(19) United States
(12) Patent Application Publication
(10) Pub. No.: US 2008/0237332 A1
(43) Pub. Date: Oct. 2, 2008

(54) SHEET PROCESSING SYSTEM, SHEET PROCESSING APPARATUS, PARTITIONING CARDS, AND SHEET PROCESSING METHOD

(75) Inventor: Mitsuo Suwa, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/046,909

(22) Filed: Mar. 12, 2008

(30) Foreign Application Priority Data
Mar. 30, 2007 (JP) 2007-095004

(51) Int. Cl. G06F 17/00

(52) U.S. Cl. 235/375

(57) ABSTRACT

Batches of media, each batch composed of sheets stacked one on another and partition card has two different side ID data items on the obverse and reverse, respectively, and an identical card ID data item on both the obverse and the reverse laid on sheets, are inserted into sheet processing apparatus. In the sheet processing apparatus, media are fed, one by one. The sheets included in media are counted and stacked. As partition card is fed, side ID data items and card ID data item are detected. The amount information about sheets counted is associated with side ID data items and card ID data item, thus detected. The amount information is transmitted to a tabulating apparatus, along with side ID data items and card ID data item. In tabulating apparatus, the amount information is stored in association with side ID data items and card ID data item.

### CROSS-REFERENCE TO RELATED APPLICATIONS

This application is based upon and claims the benefit of priority from prior Japanese Patent Application No. 2007-095004, filed Mar. 30, 2007, the entire contents of which are incorporated herein by reference.

### BACKGROUND OF THE INVENTION

1. Field of the Invention

The present invention relates to a sheet processing system, a sheet processing apparatus, a partitioning card and a sheet processing method, all designed for processing sheets such as bills.

2. Description of the Related Art

A sheet processing apparatus has a medium receiving unit and a detecting unit. The medium receiving unit receives sheets, such as bills, and feeds the bills, one by one, to the detecting unit. The detecting unit detects the bills thus fed, determines the denomination of each bill and counts the bills of each denomination, thereby acquiring the total amount the bills of each denomination (i.e., amount information). The bills the sheet processing apparatus processes are, for example, cash that a customer has just deposited at a bank. The amount of the cash is added to the account that the customer has with the bank. The cash is thus duly deposited at the bank.

Hitherto available is a method of counting bills any customer hands to the bank teller, in which the teller sets bills in the medium receiving unit of a sheet processing apparatus, then inputs the information including the customer's account number, and makes the sheet processing apparatus count the bills, thereby acquiring the total amount. In this method, however, the apparatus remains idle while the teller is setting the bills in the medium receiving unit. This inevitably reduces the throughput of the sheet processing apparatus.

Jpn. Pat. Appln. KOKAI Publication No. 2002-334362, a patent document published based on a Japanese patent application, discloses a sheet processing apparatus. Batches of bills are inserted into the apparatus, with batch cards interposed between the batches of bills. Each batch card, used as a partition card, has an ID barcode printed on it. The ID barcode represents an ID number associated with the account number at which the cash has just been deposited. The apparatus recognizes the batch cards as partitioning the batches of bills and acquires the amount information about each batch of bills deposited.

In the sheet processing apparatus described above, the media inserted into it, i.e., batches of bills and the batch cards inserted between the batches, are scanned for their genuineness or reusability. If two or more media have been fed simultaneously, they may not be inspected such bills and such batch cards are ejected into a collecting bin. They are inserted into the apparatus again and then inspected in the apparatus. Thus, all media inserted into the apparatus are reliably inspected.

Media to be re-inspected may be inserted into the apparatus, in the direction opposite to that in which they were inserted into the apparatus for the first time. In this case, the amount information about the bills included in the media cannot be accurately associated with the ID number of the batch card included in the media.

In order to avoid this outcome, the teller may take out the ejected media from the collecting bin after the first inspection, and may then manually orientate the media properly and insert them into the medium receiving unit again. This inevitably increases the workload on the part of the teller.

### BRIEF SUMMARY OF THE INVENTION

According to one embodiment of the invention, there are provided a sheet processing system, a sheet processing apparatus, partition cards and a sheet processing method, which can serve to process sheets easily and accurately.

In order to attain the above object, a sheet processing system according to an embodiment of this invention comprising a sheet processing apparatus and a tabulating apparatus. The sheet processing apparatus comprising: medium receiving unit configured to receive batches of media, each batch composed of sheets stacked one on another and a partition card including two different side ID data items on the obverse and reverse, respectively, and two identical card ID data items on both the obverse and the reverse laid on the sheets; feeding unit which feeds the media, one by one, from the medium receiving unit; counting unit which counts the sheets fed by the feeding unit; card detecting unit which detects the side ID data items and the card ID data item from the partition card fed by the feeding unit; sheet stacking unit which stacks the sheets included in the media fed by the feeding unit; and transmitting unit which associates the side ID data items and card ID data item detected from the partition card by the card detecting unit, with amount information about the sheets counted by the counting unit, and for transmitting the amount information about the sheets of each batch to the tabulating apparatus, along with the side ID data items and card ID data item. The tabulating apparatus comprising:

receiving unit which receives data from the sheet processing apparatus; and storage unit which stores the amount information about the sheets stacked and the side ID data items and card ID data item, which the receiving unit has received, the side ID data items and card ID data item being associated with the amount information.

A partitioning card according to another embodiment of this invention is designed for use in partitioning a plurality of sheets. The partition card has two different side ID data items on the obverse and reverse, respectively, and two identical card ID data items on both the obverse and the reverse.

A sheet processing apparatus according to still another embodiment of this invention is configured to transmit amount information about sheets to a tabulating apparatus. The sheet processing apparatus comprising: medium receiving unit configured to receive batches of media, each batch composed of sheets stacked one on another and a partition card including two different side ID data items on the obverse and reverse, respectively, and two identical card ID data items on both the obverse and the reverse laid on the sheets; feeding unit which feeds the media, one by one, from the medium receiving unit; counting unit which counts the sheets included in the media fed by the feeding unit; card detecting unit which detects different side ID data items from the obverse and reverse of the partition card fed by the feeding unit, respectively, and detecting the same card ID data item from the obverse and reverse of the partition card; sheet stacking unit which stacks the sheets included in the media fed by the feeding unit; and transmitting unit which associates the side ID data items and card ID data item detected from the partition card by the card detecting unit, with amount information about the sheets counted by the counting unit, and for transmitting the amount information about the sheets of each batch to the tabulating apparatus, along with the side ID data items and the card ID data item.

A sheet processing method according to a further embodiment of the invention is designed for use with a sheet processing apparatus. The method comprising: inserting batches of media into the sheet processing apparatus, each batch composed of sheets stacked one on another and a partition card including two different side ID data items on the obverse and reverse, respectively, and two identical card ID data items on both the obverse and the reverse laid on the sheets; feeding the media of each batch inserted, one by one; counting the sheets fed; detecting side ID data items and a card ID data item from the partition card fed; stacking the sheets included in the media fed; and associating the side ID data items and card ID data item detected from the partition card, with amount information about the sheets counted, and storing the amount information about the sheets of each batch in association with the side ID data items and card ID data item The embodiments of the present invention can therefore provide a sheet processing system, a sheet processing apparatus, partition cards and a sheet processing method, which can serve to process sheets easily and accurately.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a diagram showing the configuration of a sheet processing system according to an embodiment of this invention;

FIG. 2 is a schematic representation of the configuration of the sheet processing apparatus illustrated in FIG. 1;

FIG. 3 is a diagram depicting an example of a batch card for use in the embodiment of the invention;

FIG. 4 is a diagram illustrating how media are set and arranged in the sheet processing apparatus, to be inspected for the first time;

FIG. 5 is a diagram illustrating how media are set and arranged in the sheet processing apparatus, to be inspected for the second time;

FIG. 6 is a block diagram showing the control systems that are provided in the sheet processing apparatus illustrated in FIG. 2;

FIG. 7 is a table showing the amount information about media, which is transmitted to the tabulating apparatus after the media have been inspected for the first time;

FIG. 8 is a table showing the amount information about the media, which is been transmitted to the tabulating apparatus after the media have been inspected again;

FIG. 9 is a table showing other amount information about other media, which is transmitted to the tabulating apparatus after the media have been inspected again;

FIG. 10 is a table showing an example of amount information that the tabulating apparatus stores in a database;

FIG. 11 is a flowchart explaining a method of processing sheets in the sheet processing apparatus shown in FIGS. 2 and 6;

FIG. 12 is a flowchart explaining how the tabulating apparatus shown in FIGS. 2 and 6 operates upon receiving data; and

FIG. 13 is a flowchart explaining how the tabulating apparatus shown in FIGS. 2 and 6 operates to tabulate amount information.

### DETAILED DESCRIPTION OF THE INVENTION

A sheet processing system and a sheet processing method, according to an embodiment of the present invention, will be described in detail with reference to the accompanying drawings.

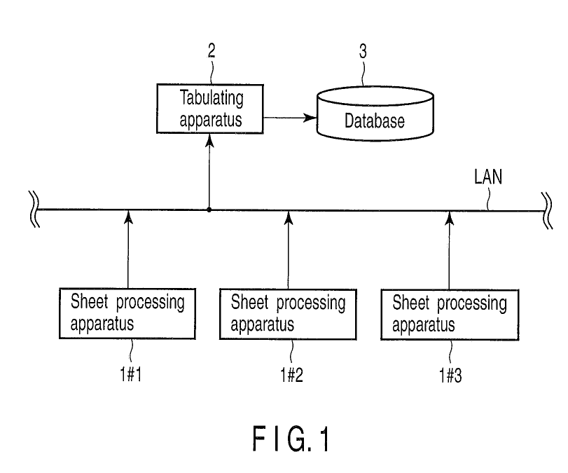

FIG. 1 is a diagram showing the configuration of the sheet processing system according to an embodiment of this invention. The sheet processing system comprises a sheet processing apparatus 1 and a tabulating apparatus 2. The sheet processing apparatus 1 inspects and counts bills, thereby generating amount information. The tabulating apparatus 2 manages and tabulates the amount information received from the apparatus 1. The tabulating apparatus 2 also controls the sheet processing apparatus 1.

The sheet processing apparatus 1 has the function of processing not only sheets such as bills, but also batch cards used as partition cards. On each batch card, a barcode is printed, which represents an ID number. Upon detecting a batch card, the sheet processing apparatus 1 associates the ID number of the card with the amount information about the bills, and then transmits the ID number and the amount information to the tabulating apparatus 2. The sheet processing apparatus 1 processes batches of media, one after another. Each batch consists of bills to be inspected and a batch card associated with these bills.

The tabulating apparatus 2 is constituted by, for example, a personal computer. The tabulating apparatus 2 controls the sheet processing apparatus 1, sets the operating mode of the sheet processing apparatus 1, and manages the data processed by the sheet processing apparatus 1. Further, the tabulating apparatus 2 stores, in a database 3, the amount information received from the sheet processing apparatus 1 in association with the ID number of the batch card.

The sheet processing apparatus 1 and the tabulating apparatus 2 are connected to each other by, for example, a LAN. Note that a plurality of identical sheet processing apparatuses 1 may be connected to the tabulating apparatus 2.

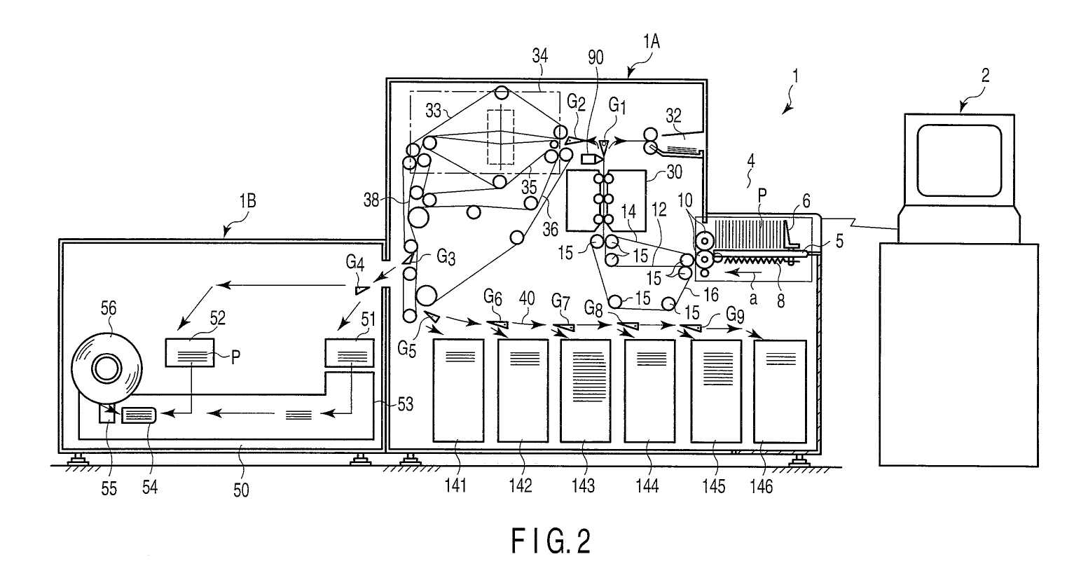

FIG. 2 is a schematic representation of the configuration of the sheet processing apparatus 1 illustrated in FIG. 1.

As FIG. 2 shows, the sheet processing apparatus 1 has a sorting/collecting device 1A and a bundling device 1B. The sorting/collecting device 1A sorts and collects bills in accordance with denomination and condition. The sorting/collecting device 1A also acquires amount information about the bills collected. The bundling device 1B bundles groups of bills, each consisting of the same number of bills of the same denomination. Note that the bundling device 1B can be dispensed of.

Into the sorting/collecting device 1A, batches of media are inserted at a time. The sorting/collecting device 1A sorts the bills of each batch into groups in accordance with denomination and condition. Of the media thus sorted, the groups of bills are transported from the sorting/collecting device 1A to collecting cassettes 141 to 146, respectively, provided in the sorting/collecting device 1A. Alternatively, the groups of bills are transported to the bundling device 1B.

The sorting/collecting device 1A has a medium receiving unit 4, into which media are inserted. The medium receiving unit 4 has a processing tray 5, a backup plate 6, and feed rollers 10. On the processing tray 5, media including bills and batch cards are set, each standing on the upper or lower edge.

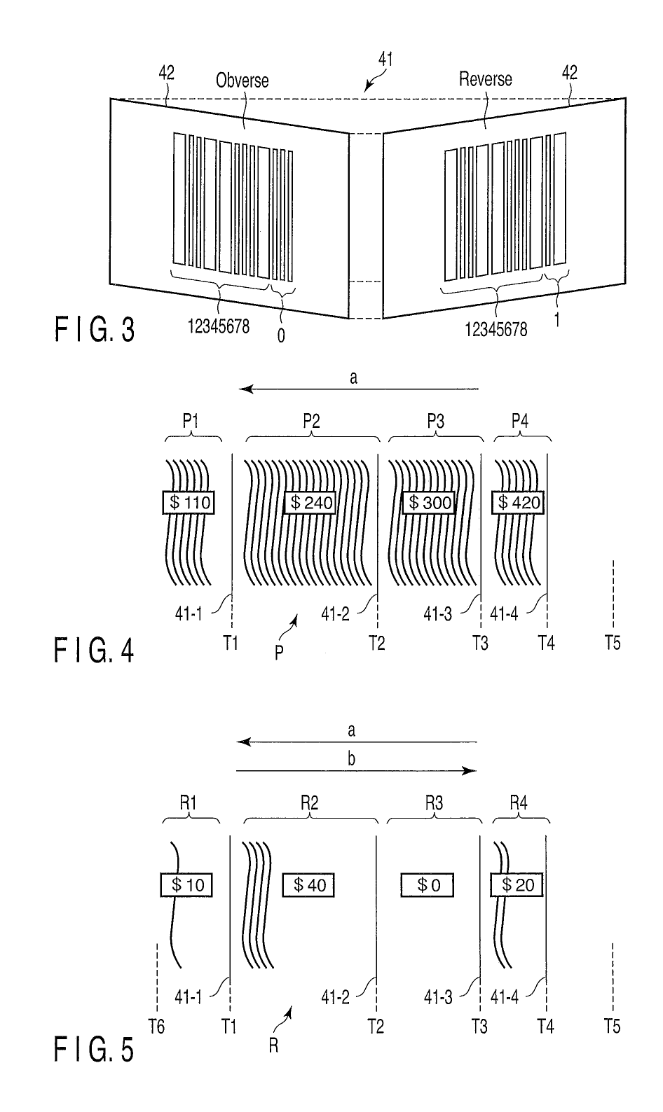

FIG. 3 shows an example of a batch card for use in the embodiment of the invention. FIG. 4 illustrates how media may be arranged in the medium receiving unit 4.

As shown in FIG. 3, the batch card 41 has a main body 42 that is rectangular like a bill. A barcode, which is a nine-digit ID number, is printed on either side of the main body 42 as shown in FIG. 3. The ID number thus printed is composed of an eight-digit card ID number and a one-digit side ID number. The side ID number indicates the side of the sheet 41, the obverse or the reverse, on which the barcode is printed. More precisely, a card ID number (12345678) and a side ID number (0) are printed on the obverse, while the same card ID (12345678) and a side ID number (1) are printed on the reverse.

The sheet processing apparatus 1 reads the barcode data printed on one side of the batch card 41, determining which side of the batch card 41 it has just scanned. Either side ID number is 0 or 1, never being any other number. Note that batch cards 41 differ in thickness from bills so that they may be easily distinguished from bills. Batch cards 41 and bills placed on the processing tray 5 of the sorting/collecting device 1A and arranged as is illustrated in FIG. 4.

On the processing tray 5, batches of media P1 to P4 are arranged, too, as shown in FIG. 4. Each of these batches includes bills of different denominations. Batch cards 41-1 to 41-4 are arranged at the rear of the batches P1 to P4, respectively.

Assume that four batches of media, P1 to P4, have been inserted at a time into the medium receiving unit 4, and that each bill P, which is a rectangular sheet, is positioned with its upper or lower longer edge contacting the process tray 5.

As shown in FIG. 2, the backup plate 6 stands upright, or perpendicular to the process tray 5. A spring 8 biases the backup plate 6 toward the feed rollers 10, along the process tray 5 (in the direction of arrow a shown in FIG. 2). The feed rollers 10 are a pair of rollers. When rotated in prescribed directions, the feed rollers 10 function as unit which feeds the media P forward, one by one, from the process tray 5. Hence, the backup plate 6 moves the media P inserted into the medium receiving unit 4, in the direction of arrow a. The foremost medium P is therefore pushed onto the feed rollers 10.

At the back of the feed rollers 10, a transport path 12 is provided. The transport path 12 is composed of a plurality of transport rollers 15 and transport belts 14 and 16. The rollers 15 drive the transport belts 14 and 16, which feed media P fed from feed rollers 10, sequentially, one by one, through the transport path 12. Each medium P is fed by the feed rollers 10 in, for example, the widthwise direction, with its upper or lower edge positioned forward. In the transport path 12, some of the media P fed from by the feed rollers 10 lie with the obverse turned up, while the others lie with the obverse turned down. In the configuration of FIG. 2, all media P fed from the medium receiving unit 4 into the transport path 12 lie with the obverse turned down.

On the transport path 12A, a detecting unit 30 is provided. The detecting unit 30 has various sensors and can read various information items from the media P being transported in the transport path 12. The information items are, for example, the denomination of each medium P, the data items representing whether each medium P is turned up or down, whether it stands on the upper or lower edge and whether it is stained or damaged. The sensors the detecting unit 30 has are, for example, an image sensor, a thickness sensor, a magnetism sensor, and the like. The image sensor reads the images printed on each medium P. The thickness sensor detects the thickness of each medium P. The magnetism sensor detects the magnetism emanating from a magnetic member, if any, provided in each medium P. From the information items the sensors of the detecting unit 30, a decision unit, which will be described later, determines the various characterizing features of each medium P, such as the image printed on it, thickness, magnetic data, and the like.

In the sorting/collecting device 1A shown in FIG. 2, media P lying in various positions with respect to sides and edges are inserted into the medium receiving unit 4. Therefore, the media P passing by the detecting unit 30 remain in various positions in respect of the side (obverse or reverse) and the longer edge (upper or lower).

Note that each medium P passing by the detecting unit 30 may assume four different positions. In the following description, any medium P that has its obverse turned up and its upper edge positioned forward will be called front-forward (FF) bill; any medium P that has its obverse turned up and its lower edge positioned forward will be called front-rearward (FR) bill; any medium P that has its reverse turned up and its upper edge positioned forward will be called back-forward (BF) bill; and any medium P that has its reverse turned up and its lower edge positioned forward will be called back-rearward (BR) bill. Thus, each medium P being transported in the transport path 12 assumes one of these four specific positions as it passes by the detecting unit 30.

On the transport path 12 and at the back of the detecting unit 30, a card detector 90 is provided, which functions as unit which detects the batch cards 41. The card detector 90 is constituted by, for example, a barcode reader. It reads the card ID number and side ID number from the barcode printed on any batch card 41 passing before it.

On the transport path 12 and at the back of the card detector 90, a plurality of gates G1 to G9 are provided. Gates G1 to G9 are configured to change the direction in which to transport each medium P further, in accordance with the position the detecting unit 30 has detected of the medium P.

Gate G1 sorts media P into ones that can be processed further and ones that should be rejected. For example, any medium P The media P that the detecting unit 30 has detected as not able to be processed, or as being non-reusable, is rejected and ejected into a rejected medium bin 32. Rejected media are: batch cards 41, two or more bills fed at the same time; bills skewed by angles greater than a preset value: bills damaged too much to be circulated again; and counterfeit bills. Thus, batch cards 41 and rejected media R, i.e., non-reusable bills, which lie between the batch cards 41, are stacked in the rejected medium bin 32.

In the rejected medium bin 32, a rejected medium detector may be provided, if necessary, to detect any rejected media R ejected into the rejected medium bin 32. The rejected medium bin 32 can be accessed from outside the sheet processing apparatus 1. The teller can therefore take the rejected media R out of the rejected medium bin 32.

On the other hand, any medium P, i.e., bills, which has been detected by the detecting unit 30 and which can pass through gate G1 and then reach gate G2. Gate G2 sorts the bills P in accordance with whether they lie turned up or down. The downstream end of gate G2 is branched into two paths. That is, gate G2 sorts the coming bills P into a group of bills lying with the obverse turned up and another group of bills lying with the obverse turned down, and guides the bills P of the first group into one path and the bills P of the second group into the other path.

On one of the paths extending downstream of gate G2, a medium inverting mechanism 34 (medium inverting unit) is provided to turn bills P upside down, if necessary. The other path 36 extending downstream of gate G2 is a transport path that allows passage of bills P without turning them upside down. As a result, all bills lie with the obverse turned in the same direction, either up or down, at a position downstream of gate G2.

The medium inverting mechanism 34 has two transport belts 33 and 35. The transport belts 33 and 35 constitute a twisted transport path that is twisted by 180° around its axis and extends from gate G2 to gate G3. Any bill P gate G2 has sorted to the medium inverting mechanism 34 is therefore turned upside down. For example, any FF bill is turned upside down by the medium inverting mechanism 34 and therefore changed to a BF bill.

Any bill P that has been turned upside down in the medium inverting mechanism 34 and any bill P that has passed through the path 36 (transport path), not passing through the mechanism 34, are fed to gate G3 through a confluence section 38.

The time (transport time) a bill P travels from gate G2 to the confluence section 38 through the medium inverting mechanism 34 is set equal to the time a bill P travels from gate G2 to the confluence section 38 through the transport path 36. Hence, two bills P transported through the mechanism 34 and the transport path 36 pass through the confluence section 38 at the same time. As a result, all bills P, now being BF bills, are sent to gate G3.

Gate G3 is designed to sort the bills P coming through the confluence section 38. A transport path, which is provided downstream of gate G3, branched into two paths. Gate G3 sorts and guides the bills P, some into one path and the others into the other, in accordance with the denomination (or condition) of each bill.

One of the paths extending from gate G3 transports bills P to, for example, the bundling device 1B. The other path 40 (i.e., horizontal path) extending from gate G3) transports bills P, which will be sorted into the six collecting cassettes 141 to 146. This path 40 extends almost horizontally, above the collecting cassettes 141 to 146. Above the horizontal transport path 40, five gates G5 to G9 are arranged to sort bills P into the six collecting cassettes 141 to 146. In the collecting cassettes 141 to 146, six sensors are provided, respectively, to detect whether the cassettes 141 to 146 contain bills P or not.

Any bill P sorted by gate G5 that is located most upstream on the horizontal transport path 40 is collected in collecting cassette 141. Any bill P sorted by gate G6 is collected in collecting cassette 142. Any bill P sorted by gate G7 is collected in collecting cassette 143. Any bill P sorted by gate G8 is collected in collecting cassette 144. And any bill P sorted by gate G9 is collected in collecting cassette 145 or collecting cassette 146. The several transport paths described above, gates G1 to G9, and the collecting cassettes 141 to 146 constitute unit which stacks media P.

As shown in FIG. 2, the bundling device 1B has a gate G4, a collecting cassette 51, a collecting cassette 52, a medium feeding unit 53, a bundling mechanism 54, a printing mechanism 55, a band feeding unit 56, and a gate G4. The collecting cassettes 51 and 52 receive bills P transported from the sorting/collecting device 1A and coming through gate G4. The bills P are bundled with paper band, providing bundles of bills, each bundle consisting of the same number of bills. The collecting cassettes 51 and 52 have a sensor each. The sensor detects the number of bills P stacked in the collecting cassette.

The medium feeding unit 53 feeds a preset number of bills (for example, 100 bills) from the collecting cassette 51 or 52 to the bundling mechanism 54. The bundling mechanism 54 is a mechanism that bundles a preset number of bills P (for example, 100 bills) together with a paper band, forming a bundle. The printing mechanism 55 prints desired data on the paper bands that are used in the bundling mechanism 54. The band feeding unit 56 feeds paper bands to the bundling mechanism 54.

Gate G3 of the sorting/collecting device 1A guides a bill P into the bundling device 1B through the transport path extending to the left as shown in FIG. 2. In the bundling device 1B, the bill P thus fed from the sorting/collecting device 1A is guided by gate G4 in one direction or the other. More precisely, the bill P is guided into the collecting cassette 51 or the collecting cassette 52.

The bills P stacked in the collecting cassette 51 or 52 are fed altogether by the medium feeding unit 53 to the bundling mechanism 54. The bundling mechanism 54 bundles a prescribed number of bills P fed by the medium feeding unit 53, with a paper band fed from the band feeding unit 56, forming a bundle of bills P. The bundle of bills P is transported outside the sheet processing apparatus 1 by means of a conveyor (not shown).

Bills P of any specified denomination can be supplied, as needed, from the sorting/collecting device 1A to the bundling device 1B. On the other hand, the bills P other than those of the specific denomination to be bundled by the bundling device 1B are stacked in any one of the collecting cassettes 141 to 146 of the sorting/collecting device 1A.

Assume that media P1 to P4 have been fed and a batch card 41 has been detected. If no other media P are fed for a prescribed time thereafter, the sorting/collecting device 1A determines that the batch card 41 is the last medium set on the process tray 5. Then, the device 1A automatically stops receiving media P. The collecting cassettes are automatically locked, safekeeping the bills P. Thus, the process of stacking the bills P is completed.

The media P rejected because they have been fed from the process tray 5 simultaneously are removed by the teller from the rejected medium bin 32. The teller then sets these media P from the rejected medium bin 32 and sets them again on the process tray 5. Thereafter, these media P are sorted and stacked in the sorting/collecting device 1A.

The control systems provided in the sheet processing apparatus 1 will be described.

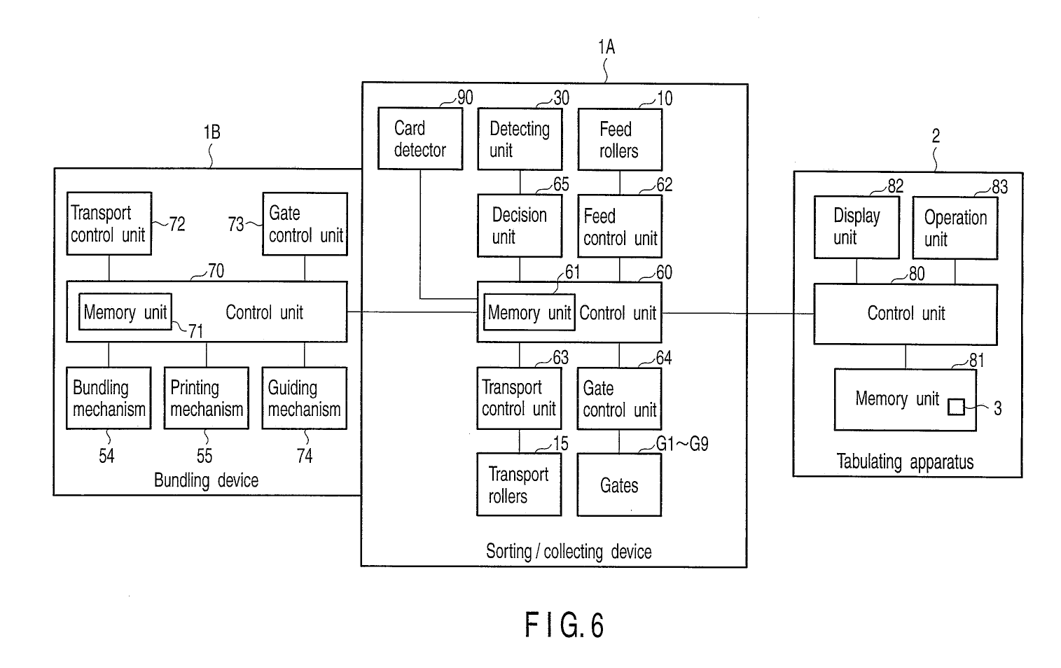

FIG. 6 is a block diagram showing the control systems that is incorporated in the sheet processing apparatus 1 illustrated in FIG. 2.

As FIG. 6 shows, the control system of the sorting/collecting device 1A comprises a control unit 60, a memory unit 61, a feed control unit 62, a transport control unit 63, a gate control unit 64, a decision unit 65, and a card detector 90.

The card detector 90 detects the card ID number and the side ID number, both printed as a barcode on each batch card 41. The information thus detected is sent to the control unit 60. The information items read from the barcodes printed on the batch cards 41 can therefore be accumulated in the memory unit 61.

The feed control unit 62 is configured to drive the feed rollers 10 under the control of the control unit 60.

The transport control unit 63 is designed to drive the transport rollers 15 under the control of the control unit 60.

The decision unit 65 configured to decide, able to determine the condition of each sheet such as a bill P, which has been detected by the detecting unit 30. More specifically, the decision unit 65 compares the information read by the various sensors with reference information, thereby determining the characterizing features of the bill P.

The decision unit 65 determines, for example, which denomination the bill P presents, which side of the bill P is turned up (obverse or reverse), and which edge of the bill P is positioned forward (upper edge or lower edge). Further, the decision unit 65 determines whether the bill P can be circulated or damaged too much to be circulated, in accordance with the various conditions of the bill P. More precisely, the decision unit 65 makes this decision in accordance with how much the bill P is stained, torn and folded, how much it is degraded in quality, and how much it has been repaired with tape.

The control unit 60 counts bills P that have been determined to be circulated by the decision unit 65.

The decision unit 65 can detect counterfeit bills, if any, and can transmit the result of this detection to the control unit 60.

The gate control unit 64 drives gates G1 to G3 and gates G5 to G9 under the control of the control unit 60. For example, a batch card 41 or a counterfeit bill may be detected. In this case, the control unit 60 drives gate G1, which guides the batch card 41 or the counterfeit bill into the rejected medium bin 32. That is, the control unit 60 and gate G1 function as unit which rejects a medium so that the medium may be removed from the sheet processing apparatus 1.

The control unit 60 controls some of the other components of the sorting/collecting device 1A in accordance with a prescribed operating program. The memory unit 61 stores programs the control unit 60 may executes. The control unit 60 acquires the amount information about the bills of each batch, which is based on the denominations the decision unit 65 has determined in respect of these bills. Thus, the control unit 60 configured to count. The memory unit 61 holds a tabulation table that counts the media stacked in each of the collecting cassettes 141 to 146 and the media stacked in each of the collecting cassettes 51 and 52 provided in the bundling device 1B.

Moreover, the memory unit 61 stores various preset information items the control unit 60 uses when it executes the operating program of the sorting/collecting device 1A. Among these preset information items are: the preset feed torques the feed control unit 62 may use; the reference values the decision unit 65 may compare with the values detected by various sensors; the various sensor output levels the transport control unit 63 may use; the angle information that is a tolerant angular limitation of each medium P; and the selected collection cassettes and the denominations of the bills to be collected.

No media P may be transported upon lapse of a predetermined time after the control unit 60 has received the information indicating the detection of a batch card 41. If this is the case, the control unit 60 determines that the batch card 41 is the last media placed on the process tray 5. Accordingly, the control unit 60 instructs the feed control unit 62 to stop feeding media P. When so instructed, the feed control unit 62 stops driving the feed rollers 10.

When media P are inserted into the medium receiving unit 4, the sorting/collecting device 1A stacks these media P and counts the bills included in these media P. The sorting/collecting device 1A immediately transmits the amount information about the bills to the tabulating apparatus 2. Assume that media P1 shown in FIG. 4 are inserted into the unit 4 in the direction of arrow a. Then, the sorting/collecting device 1A counts the bills included in these media P1, acquiring amount information representing the sum these bills present. At timing T1 the card detector 90 detects the card ID number and the side ID number, both printed on batch card 41-1, the sorting/collecting device 1A associates the card ID number and the side ID number with the amount information about media P1 and transmits the amount information to the tabulating apparatus 2, along with the card ID number and side ID number of batch card 41-1.

Next, the sorting/collecting device 1A detects media P2 and acquires the amount information representing the sum the bills included in these media P2 present. At timing T2, the card detector 90 detects the card ID number and the side ID number, both printed on batch card 41-2, the sorting/collecting device 1A associates the card ID number and side ID number of batch card 41-1 with the amount information about media P1 and P2, and transmits the amount information about media P1 and P2 to the tabulating apparatus 2, along with the card ID number and side ID number of batch card 41-1. That is, the device 1A associates the side ID number read from batch card 41-1 with the amount information about media P1 and then associates the side ID number opposite to the side ID number read, with the amount information about media P2.

Further, the sorting/collecting device 1A detects media P3 and acquires the amount information about the bills included in media P3. At timing T3, the card detector 90 detects the card ID number and the side ID number that are printed on batch card 41-3, and the sorting/collecting device 1A associates the card ID number and side ID number of batch card 41-2 with the amount information about media P2 and P3, and transmits the amount information about media P2 and P3 to the tabulating apparatus 2, along with the card ID number and side ID number of batch card 41-2.

Still further, the sorting/collecting device 1A detects media P4 and acquires the amount information about the bills included in media P4. At timing T4, the card detector 90 detects the card ID number and the side ID number, both printed on batch card 41-4, the control unit 60 of the sorting/collecting device 1A associates the card ID number and side ID number of batch card 41-3 with the amount information about media P3 and P4, and transmits the amount information about media P3 and P4 to the tabulating apparatus 2, along with the card ID number and side ID number of batch card 41-3. That is, the control unit 60 has transmitting unit which transmits data to the tabulating apparatus 2.

Assume that no media are detected upon lapse of a predetermined time after a medium has been detected for the last time, or at timing T5. Then, the sorting/collecting device 1A determines that no media are left on the process tray 5. The device 1A then associates the card ID number and side ID number of batch card 41-4 with the amount information about media P3 and P4, and transmits the amount information about any media P detected after media P4 and batch card 41-4, to the tabulating apparatus 2, along with the card ID number and side ID number of batch card 41-4. At this point, the sorting/collecting device 1A stops performing its function.

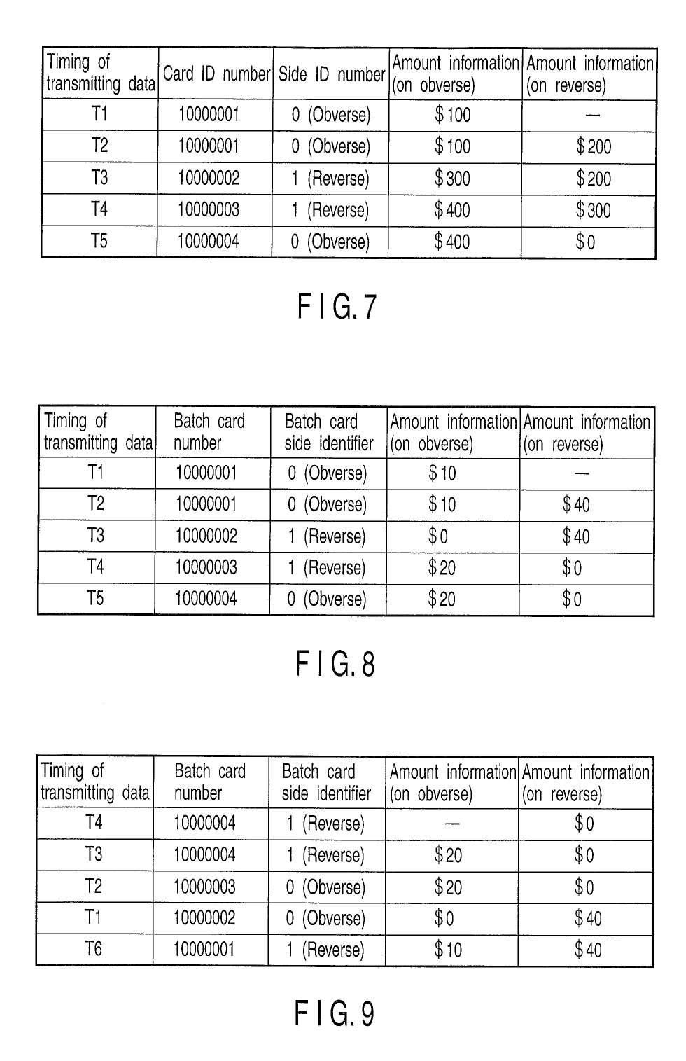

FIG. 7 is a table showing the amount information about media P, which has been transmitted to the tabulating apparatus 2 after the media P have been inspected for the first time. Timings T1 to T5 shown in FIG. 7 correspond to the data transmitting timings T1 to T5, respectively.

If the rejected media R are stacked as shown in FIG. 5 at the first inspection, the If this is the case, the teller will remove them and insert them again into the medium receiving unit 4 of the sorting/collecting device 1A so that the rejected media R may be inspected for the second time. Assume that rejected media R1 to R4 are inserted again in the direction of arrow a shown in FIG. 5. Then, rejected media R1 to R4 are sequentially detected. When each rejected medium is detected, the amount information about each rejected medium is transmitted to the tabulating apparatus 2, along with the card ID number side ID number of the batch card 41 associated with the rejected medium. As a result, such data as shown in FIG. 8 are transmitted to the tabulating apparatus 2.

Assume that rejected media R1 to R4 are inserted again into the medium receiving unit 4 of the sorting/collecting device 1A, in the direction of arrow b shown in FIG. 5. In this case, the sorting/collecting device 1A first transmits the amount information about the media R already detected, to the tabulating apparatus 2, together the card ID number side ID number of batch card 41-4, at timing T4 when the card ID number side ID number are detected from batch card 41-4.

Thereafter, as rejected media R4 to R1 are detected in the order mentioned, as in the case illustrated in FIG. 4, at timings T4, T3, T2, T1, and T6, respectively. At each timing, amount information about the rejected medium R, which is shown in FIG. 9, is transmitted to the tabulating apparatus 2, together the card ID number side ID number of the batch card 41 associated with the rejected medium R.

As FIG. 6 shows, the control system provided in the bundling device 1B of the sheet processing apparatus 1 comprises a control unit 70, a memory unit 71, a transport control unit 72, a gate control unit 73, and a guiding mechanism 74, in addition to the bundling mechanism 54 and printing mechanism 55, both described above.

The control unit 70 controls the other components of the bundling device 1B in accordance with a prescribed operating program. The memory unit 71 stores programs the control unit 70 may executes. The memory unit 71 stores various preset information items the control unit 70 uses when it executes the operating program of the bundling device 1B. These preset information items are, for example, the number of bundling units used, the pattern printed on the paper bands the bundling device 1B uses, and the like.

The transport control unit 72 is configured to drive the transport rollers under the control of the control unit 70. The gate control unit 73 is designed to drive gate G4 under the control of the control unit 70. The guiding mechanism 74 is configured to guide (transport) a prescribed number of bills P stacked in each of the collecting cassettes 51 and 52, under the control of the control unit 70.

The tabulating apparatus 2 has a control system, which comprise a control unit 80, a memory unit 81, a display unit 82, and an operation unit 83.

The control unit 80 controls the other components of the tabulating apparatus 2 in accordance with a prescribed operating program. The control unit 80 has the function of, for example, setting various information items the sorting/collecting device 1A may use, in accordance with the instructions input by the teller. The memory unit 81 stores programs the control unit 80 may executes. Further, the memory unit 81 stores various preset information items the control unit 80 uses when it executes the operating program of the tabulating apparatus 2. These preset information items are, for example, the countries in which the apparatus 1 may be used, the languages in which the messages may be displayed on the console screen, and the like.

The display unit 82 is configured to display operation guidance to the teller, under the control of the control unit 80. The operation unit 83 may be operated by the teller to input various operating instructions. The display unit 82 has, for example, a display. The operation unit 83 has input devices such as a keyboard and a mouse. The display unit 82 and the operation unit 83 may be constituted by a display that has a touch panel. Alternatively, the display unit 82 and the operation unit 83 may a combination of a display having a touch panel and an input device such as a keyboard.

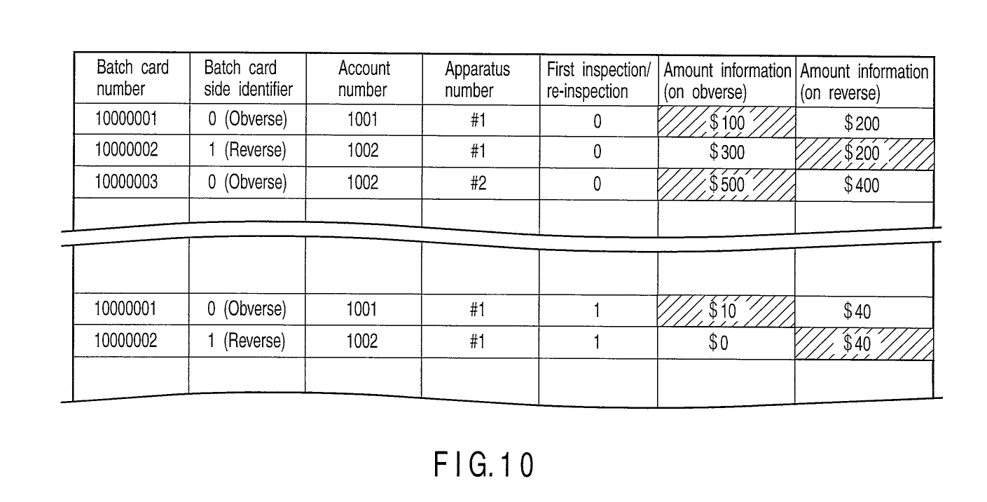

The control unit 80 comprises receiving unit which receives data from the sheet processing apparatus 1. When the control 80 receives data from the sheet processing apparatus 1, the side ID number, card ID number and amount information, all contained in the data received, are stored in the memory unit 81 that functions as storage. A database 3 of the type shown in FIG. 10 is thereby constructed. In the database 3, the information about the apparatus 1 is stored, too, in association with the data transmitted from the sheet processing apparatus 1.

Upon receiving the data containing the card ID number of any batch card, which is registered in the database 3, the control unit 80 determines that the data received has been acquired at the re-inspection of media P. The control unit 80 therefore sets first inspection/re-inspection data to 1, which shows that the data has been acquired at the re-inspection. If the data received contains a card ID number not registered in the database 3, the control unit 80 determines that the data has been acquired at the first inspection and sets first inspection/re-inspection data to 0, which shows that the data has been acquired at the first inspection.

As shown in FIG. 10, data items containing the same card ID number may be registered in the database 3. In this case, items of the amount information are tabulated in accordance with the care ID numbers. More precisely, the control unit 80 first refers to the data acquired at the first inspection. The control unit 80 then determines which amount information should be applied in the tabulation, the information about any bill at the obverse of the batch card 41 or the information about any bill at the reverse thereof, in accordance with the side ID number contained in the data.

In this instance, the control unit 80 determines that the information about the bills P at that side of the batch card 41, which the card detector 90 has scanned. Then, the control unit 80 refers to the data acquired at the re-inspection and determines that the amount information identical to that information applied to tabulate the information acquired at the first inspection should be applied. Thereafter, the control unit 80 associates the amount information items acquired at the first inspection with those acquired at the re-inspection. Thus, the control unit 80 configured to tabulation. In FIG. 10, any item hatched is amount information that should be applied to the tabulation.

The control unit 80 may perform tabulation in accordance with each account number preset, not in accordance with the card ID number of each batch card 41 as explained above. That is, the card ID numbers of batch cards 41 may be associated with the account numbers the customers have at the bank, and the amount information items may be tabulated for card ID numbers. Then, the data items with which the same card ID number is associated are collected, providing account information, and the account information thus provided is associated with the account number.

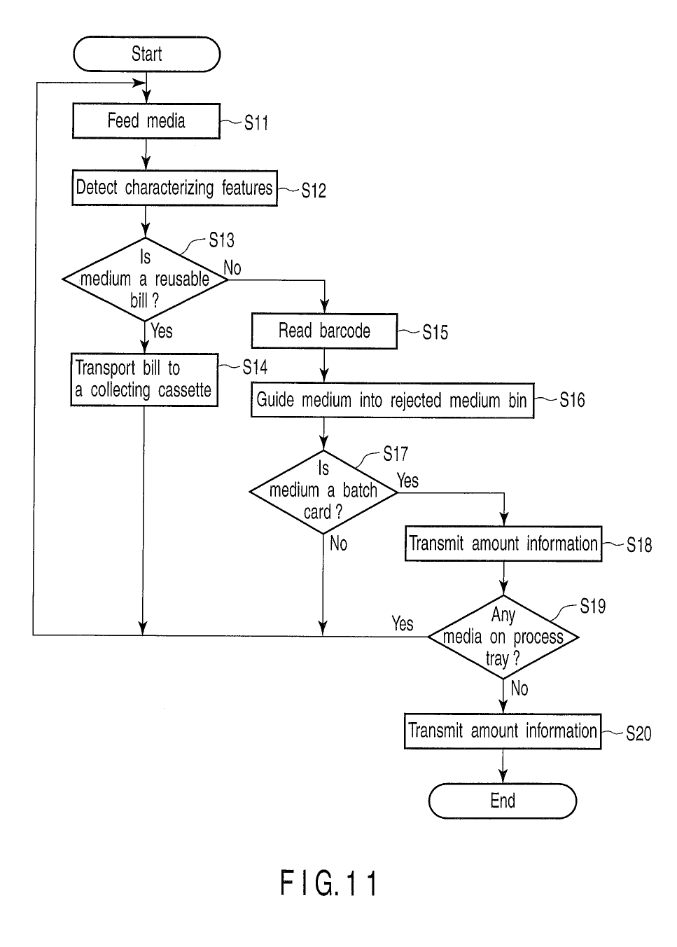

How the sheet processing apparatus 1 operates will be explained, with reference to the flowchart of FIG. 11.

FIG. 11 is a flowchart that explains a method of processing sheets in the sheet processing apparatus 1 illustrated in FIGS. 2 and 6.

Before making the apparatus 1 start operating, the teller set media P on the process tray 5 of the sorting/collecting device 1A. On the tray 5, the media P are arranged as is illustrated in FIG. 4.

In the sheet processing apparatus 1, the feed rollers 10 feed the media P, one by one, from the medium receiving unit 4 (Step S11). The medium P first fed is guided into the transport path 12.

In the sheet processing apparatus 1, the detecting unit 30 detects the characterizing features of the medium P (Step S12). More specifically, the detecting unit 30 scans the medium P at both the obverse and the reverse and detects the thickness of the medium P, determining which type it is, which side is turned up (obverse or reverse), on which edge it stands (upper or lower), how much it is stained, torn and damaged. Thus, the characterizing features of the medium P are detected.

From the characterizing features detected by the detecting unit 30, the control unit 60 provided in the sorting/collecting device 1A determines whether the medium P is a bill and whether it is a reusable one (Step S13).

If the medium P is found to be a reusable bill (YES in Step S13), the control unit 60 causes the transport control unit 63 and gate control unit 64 to drive the transport rollers 15 and gates G1 to G9. As a result, the bill P is transported to one of the collecting cassettes 141 to 146, in accordance with its denomination (Step S14). The medium P is then processed.

In Step S13, the medium P may not be found to be a bill or a reusable bill (NO in Step S13), the control unit 60 makes the card detector 90 read the barcode printed on the obverse of the medium P (Step S15). Then, the control unit 60 causes the transport control unit 63 and gate control unit 64 to drive the transport rollers 15 and the G1. The medium P is thereby guided into the rejected medium bin 32 (Step S16).

From the data the card detector 90 has read, the control unit 60 determines whether the medium P is a batch card 41 (Step S17). More precisely, the detector 60 determines that the medium P is a batch card 41 if the data the card detector 90 has read is a card ID number and a side ID number.

If the medium P is not be found to be a batch card 41 in Step S17, (NO in Step S17), the control unit 60 determines that the medium P is a rejected bill. Then, the sorting/collecting device 1A starts processing the next medium P fed by the feed rollers 10.

In Step S17, the medium P may be found to be a batch card 41 (YES in Step S17). In this case, the control unit 60 transmits the amount information about the bills P stacked, to the tabulating apparatus 2, along with the card ID number side ID number of the batch card 41 associated with the bills P (Step S18). Note that the control unit 60 associates the amount information about the bills P, with the card ID number and side ID number of the batch card 41, as described above with reference to FIG. 6.

Then, the control unit 60 determines whether any media P remain on the process tray 5 (Step S19). The control unit 60 determines that no media P lies on the process tray 5 if no medium P is detected at the tray 5 upon lapse of a predetermined time after a medium has been detected for the last time.

If the control unit 60 determines that no media P remain on the process tray 5 (NO in Step S19), it transmits the amount information about the bills P stacked after the batch card 41, to the tabulating apparatus 2, along with the card ID number side ID number of the batch card 41 (Step S20). Thus, the processing of the media P is terminated in the sorting/collecting device 1A.

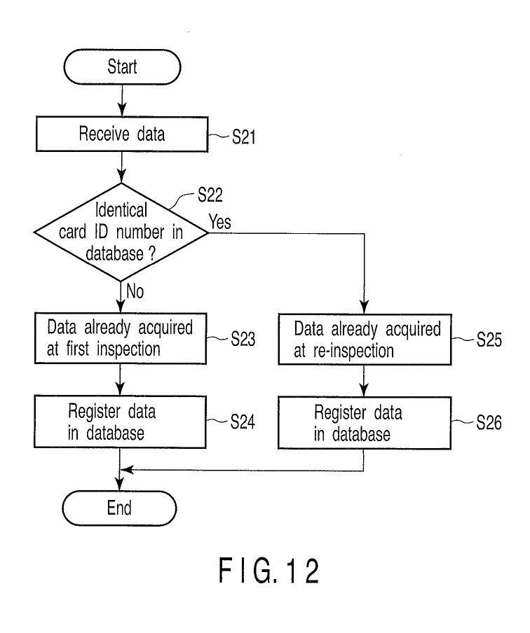

How the tabulating apparatus 2 operates will be explained with reference to the flowchart of FIG. 12.

FIG. 12 is a flowchart explaining how the tabulating apparatus 2 shown in FIGS. 2 and 6 operates upon receiving data.

Upon receiving data from the sheet processing apparatus 1 (Step S21), the control unit 80 determines whether the database 3 holds the data containing the card ID number that is identical to the card ID number contained in the data received (Step S22). If the database 3 does not hold this data (NO in Step S22), the controller 80 determines that the data received has been acquired at the first inspection (Step S23). The control unit 80 therefore sets the first inspection/re-inspection data to 0, which is registered in the database 3 (Step S24).

In Step S22, the control unit 80 may determine that the database 3 holds the data containing the card ID number identical to the card ID number contained in the data received. In this case (YES in Step S22), the control unit 80 determines that the data received has been acquired at the re-inspection (Step S25). In this case, the control unit 80 sets the first inspection/re-inspection data to 1, which is registered in the database 3 (Step S26).

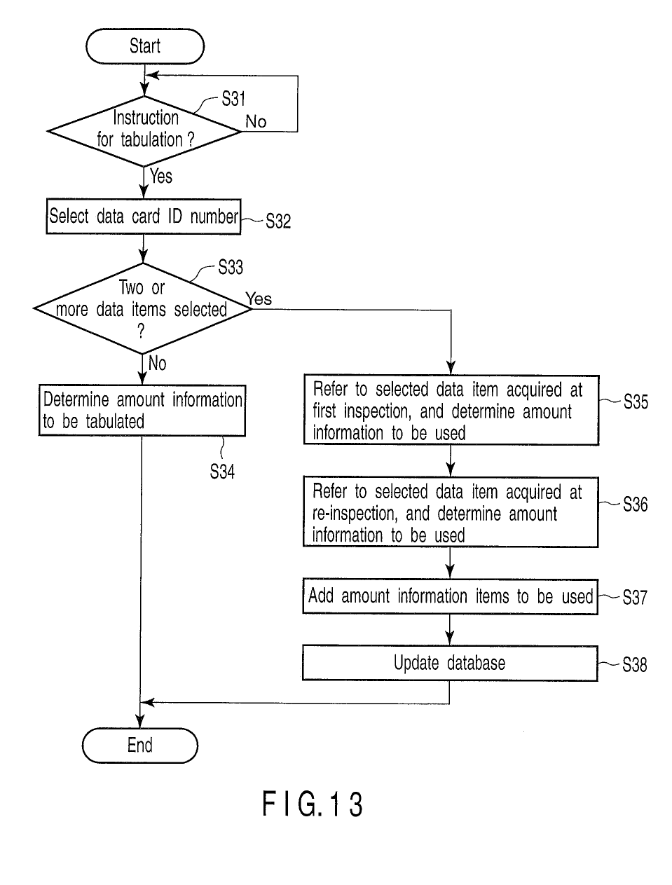

FIG. 13 is a flowchart explaining how the tabulating apparatus 2 shown in FIGS. 2 and 6 operates to tabulate amount information.

The teller may operate the operation unit 83 of the tabulating apparatus 2, instructing the apparatus 2 to initiate tabulation (YES in Step S31). In accordance with the instruction input by the teller, the control unit 80 selects data that contains the card ID number the teller has designated (Step S32). The control unit 80 then determines whether two or more such data items have been selected (Step S33).

If the control unit 80 determines that one data item has been selected (NO in Step S33), it determines which amount information should be tabulated, the information about the bills on the obverse of the batch card 41 or the information about the bills on the reverse thereof, in accordance with the side ID number contained in the data selected (Step S34). In most cases, the control unit 80 uses the amount information about the bills P arranged on that side of the batch card 41 which the card detector 90 has scanned.

The control unit 80 may determine that two or more data items have been selected (YES in Step S33). In this case, the control unit 80 first refers to the selected data item acquired at the first inspection, and determines which amount information should be used, the information about the bills on the obverse of the batch card 41 or the information about the bills on the reverse thereof, in accordance with the side ID number contained in the data (Step S35).

Next, the control unit 80 refers to the data acquired at the re-inspection and determines that the amount information should be used, which has been used to tabulate the data acquired at the first inspection (Step S36).

Further, the control unit 80 adds the amount information items to be used, one to another, generating sum information (Step S37). The control unit 80 designates the sum information as amount information associated with the card ID number the teller has designated. The amount information associated with that card ID number is registered in the database 3. The control unit 80 then updates the database 3, deleting the selected data (Step S38). The tabulating apparatus 2 then finishes performing its function.

In the sheet processing system so configured as described above, the sheet processing apparatus 1 transmits the amount information about the bills P, some arrange at the obverse of the batch card 41 and the others arranged at the reverse of the batch card 41, to the tabulating apparatus 2, along with the card ID number and side ID numbers of the batch card 41. In the tabulating apparatus 2, the data received is registered in the database 3 such that the data items acquired at the first inspection and re-inspection, respectively, are distinguished from each other.

To tabulate the data items acquired at the first inspection and re-inspection, respectively, the tabulating apparatus 2 first refers to the data item acquired at the first inspection and then determines which amount information, the information about the bills at the obverse of the batch card 41 or the information about the bills at the reverse of the batch card 41, should be associated with the batch card 41. The tabulating apparatus 2 then refers to the data item acquired at the re-inspection and associates the amount information about the bills at the same side of the batch card 41 as the bills were arranged at the first inspection. Then, the tabulating apparatus 2 tabulates the amount information acquired at the first inspection and associated with the batch card 14 and the amount information acquired at the re-inspection and associated also with the batch card 14. Thus, the tabulating apparatus 2 generates tabulated information for one batch of media P.

In the present invention, media are inspected a plurality of times. Even if the media are inserted again in the direction opposite to that in which they were inserted for the first time, the amount information about media inserted again can be associated with the same batch card as it was associated for the first time. The present invention can therefore provide a sheet processing system, a sheet processing apparatus, partition cards and a sheet processing method, which can serve to process sheets easily and accurately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sheet processing system comprising a sheet processing apparatus and a tabulating apparatus,
the sheet processing apparatus comprising:
medium receiving unit configured to receive batches of media, each batch composed of sheets stacked one on another and a partition card including two different side ID data items on the obverse and reverse, respectively, and two identical card ID data items on both the obverse and the reverse laid on the sheets;
feeding unit which feeds the media, one by one, from the medium receiving unit;
counting unit which counts the sheets fed by the feeding unit;
card detecting unit which detects the side ID data items and the card ID data item from the partition card fed by the feeding unit;
sheet stacking unit which stacks the sheets included in the media fed by the feeding unit; and
transmitting unit which associates the side ID data items and card ID data item detected from the partition card by the card detecting unit, with amount information about the sheets counted by the counting unit, and for transmitting the amount information about the sheets of each batch to the tabulating apparatus, along with the side ID data items and card ID data item, and
the tabulating apparatus comprising:
receiving unit which receives data from the sheet processing apparatus; and
storage unit which stores the amount information about the sheets stacked and the side ID data items and card ID data item, which the receiving unit has received, said side ID data items and card ID data item being associated with the amount information.

2. The sheet processing system according to claim 1, wherein the transmitting unit comprises unit which associates the side ID data item and card ID data item detected from the obverse of the partition card, with the amount information about sheets of a batch stacked on the obverse of the partition card, for associating the side ID data item and card ID data item detected from the reverse of the partition card, with the amount information about the sheets of another batch stacked on the reverse of the partition card, and for transmitting the amount information about the sheets of each batch to the tabulating apparatus, along with the side ID data items and card ID data item detected from the obverse or reverse of the partition card.

3. The sheet processing system according to claim 1, wherein the sheet processing apparatus further comprises:
decision unit which determines whether the sheets fed by the feeding unit are reusable; and
rejecting unit which rejects the partition card and any sheet found not to be reusable by the decision unit, thereby to eject the partition card and the sheet from the sheet processing apparatus.

4. The sheet processing system according to claim 1, wherein the tabulating apparatus further comprises tabulating unit which tabulates the amount information about sheets of each batch, which is stored in the storage unit and association with the card ID data item.

5. The sheet processing system according to claim 4, wherein the tabulating unit has unit which tabulates amount information items associated with the same card ID data item, which are associated also with the same side ID data item.

6. The sheet processing system according to claim 1, wherein the tabulating apparatus further comprises tabulating unit which associates a plurality of card ID data items with account data items respectively, and for tabulating the amount information about the sheets, which is stored in the storage unit.

7. A partitioning card for use in partitioning a plurality of sheets, which has two different side ID data items on the obverse and reverse, respectively, and two identical card ID data items on both the obverse and the reverse.

8. A sheet processing apparatus for transmitting amount information about sheets to a tabulating apparatus, the sheet processing apparatus comprising:
medium receiving unit configured to receive batches of media, each batch composed of sheets stacked one on another and a partition card including two different side ID data items on the obverse and reverse, respectively, and two identical card ID data items on both the obverse and the reverse laid on the sheets;
feeding unit which feeds the media, one by one, from the medium receiving unit;
counting unit which counts the sheets included in the media fed by the feeding unit;
card detecting unit which detects different side ID data items from the obverse and reverse of the partition card fed by the feeding unit, respectively, and detecting the same card ID data item from the obverse and reverse of the partition card;
sheet stacking unit which stacks the sheets included in the media fed by the feeding unit; and
transmitting unit which associates the side ID data items and card ID data item detected from the partition card by the card detecting unit, with amount information about the sheets counted by the counting unit, and for transmitting the amount information about the sheets of each batch to the tabulating apparatus, along with the side ID data items and the card ID data item.

9. The sheet processing apparatus according to claim 8, wherein the transmitting unit comprises unit which associates the side ID data item and card ID data item detected from the obverse of the partition card, with the amount information about sheets of a batch stacked on the obverse of the partition card, for associating the side ID data item and card ID data item detected from the reverse of the partition card, with the amount information about the sheets of another batch stacked on the reverse of the partition card, and for transmitting the amount information about the sheets of each batch to the tabulating apparatus, along with the side ID data items and card ID data detected from the obverse or reverse of the partition card.

10. The sheet processing apparatus according to claim 8, wherein the sheet processing apparatus further comprises:
decision unit which determines whether the sheets fed by the feeding unit are reusable; and
rejecting unit which rejects the partition card and any sheet found not to be reusable by the decision unit, thereby to eject the partition card and the sheet from the sheet processing apparatus.

11. A sheet processing method for use with a sheet processing apparatus, comprising:
inserting batches of media into the sheet processing apparatus, each batch composed of sheets stacked one on another and a partition card including two different side ID data items on the obverse and reverse, respectively, and two identical card ID data items on both the obverse and the reverse laid on the sheets;
feeding the media of each batch inserted, one by one;
counting the sheets fed;
detecting side ID data items and a card ID data item from the partition card fed;
stacking the sheets included in the media fed; and
associating the side ID data items and card ID data item detected from the partition card, with amount information about the sheets counted, and storing the amount information about the sheets of each batch in association with the side ID data items and card ID data item.

12. The sheet processing method according to claim 11, wherein the side ID data item and card ID data item detected from the obverse of the partition card are stored in association with the amount information about the sheets stacked on the obverse the partition card, and the side ID data item and card ID data item detected from the reverse of the partition card are stored in association with the amount information about the sheets stacked on the reverse the partition card.

13. The sheet processing method according to claim 11, wherein:
it is determined whether media inserted into the sheet processing apparatus are reusable;
sheets found not to be reusable and the partition card ejected, as rejected media, from the sheet processing apparatus;
the rejected media are inserted into the sheet processing apparatus;
the rejected media are fed, one by one;
counting the sheets included in the rejected media fed;
the side ID data items and the card ID data item are detected from the partition card included in the rejected media fed;
the sheets included in the media fed; and
the amount information about the sheets included in the rejected media is stored in association with the side ID data items and card ID data item detected from the obverse and reverse of the partition card included in the rejected media.

14. The sheet processing method according to claim 13, wherein the amount information stored is tabulated in respect of the amount information items associated with identical card ID data items.

15. The sheet processing method according to claim 11, wherein card ID data items of a plurality of partition cards are associated with account data items respectively, and the amount information about the sheets, which is stored, is tabulated in respect of the amount information items associated with identical account data items.
